(19) United States
(12) Patent Application Publication
(10) Pub. No.: US 2020/0348669 A1
(43) Pub. Date: Nov. 5, 2020

(54) AUTONOMOUS DRIVING CONTROL APPARATUS, VEHICLE INCLUDING AUTONOMOUS DRIVING CONTROL APPARATUS, AND METHOD OF CONTROLLING VEHICLE

(71) Applicants: Hyundai Motor Company, Seoul (KR); Kia Motors Corporation, Seoul (KR)

(72) Inventors: Hyungjin Kim, Seoul (KR); Inyong Jung, Incheon (KR); Kyungho Kim, Seongnam-si (KR)

(73) Assignees: Hyundai Motor Company, Seoul (KR); Kia Motors Corporation, Seoul (KR)

(21) Appl. No.: 16/401,288

(22) Filed: May 2, 2019

(51) Int. Cl. G05D 1/00; B60W 10/22; B60W 10/30; B60W 10/06; B60W 10/18; B60W 30/18; E05F 15/73; G05D 1/02; G01C 21/20; B60G 17/015

(52) U.S. Cl. CPC G05D 1/0088; B60G 2500/30; B60W 10/30; B60W 10/06; B60W 10/18; B60W 30/18; E05F 15/73; G05D 1/0231; G05D 1/0212; G01C 21/20; B60G 17/015; G05D 2201/0213; B60W 2400/00; B60W 2420/42; B60W 2710/06; B60W 2710/18; B60W 2710/226; B60W 2710/30; E05F 2015/767; E05Y 2900/55; B60G 2500/10; B60W 10/22

(57) ABSTRACT

A vehicle may include an opening and closing device; an image acquirer acquiring an image of a road; a storage storing entry location information of a tollgate; a location receiver receiving a current location of the vehicle; a controller generating a route from the received current location to the destination, controlling road guidance based on route information of the generated route, determining whether a speed restriction section is present and a type of a lane of the vehicle based on image information of the acquired image when the received current location is an entry location of a tollgate, controlling a damping force of the suspension to be reduced when the speed restriction section is present, and controlling the opening and closing device to open or close the window when the type of the lane of the vehicle is a toll ticket lane; and a display displaying the generated route and road guidance information.

### BACKGROUND OF THE INVENTION

### Field of the Invention

The present invention relates to an autonomous driving control apparatus for controlling a driving speed based on a current location of the vehicle, a vehicle including the autonomous driving control apparatus, and a method of controlling the vehicle.

### Description of Related Art

A vehicle is a machine which travels on a road by driving wheels. The vehicle is provided with various devices for occupant protection, driving assistance, and ride quality improvement.

In addition to basic traveling functions, the vehicle performs additional functions for user convenience, such as an audio function, a video function, a navigation function, an air conditioning control, a seat control, and a lighting control.

The vehicle may be provided with an audio-video-navigation (AVN) device in which navigation, audio, and video functions are integrated.

Furthermore, the vehicle communicates with a terminal capable of performing an audio function, a video function, a navigation function, a map function, a telephone function, a radio function, a broadcast function, a text message service function, and an Internet function.

Herein, a navigation mode of performing the navigation function is a function of receiving location information from each of a plurality of satellites through a global positioning system (GPS), calculating a current location of the vehicle of the vehicle, map-matching the calculated location to a map and displaying the map, receiving a destination of the vehicle from a user, searching for a route from the calculated current location to the destination according to a preset route search algorithm, matching the found route to a map and displaying the map, and guiding the user to the destination along the route.

The vehicle performs autonomous driving to autonomously move to the destination using a navigation function and an obstacle recognition function.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an autonomous driving control apparatus which adjusts a driving speed at a preset location while a vehicle moves to a destination, a vehicle including the autonomous driving control apparatus, and a method of controlling the vehicle.

Therefore, it is another aspect of the prevent disclosure to provide an autonomous driving control apparatus configured for controlling at least one of a suspension of the vehicle, an air conditioner, a window, an engine, and a steering system, a vehicle including the autonomous driving control apparatus, and a method of controlling the vehicle.

Additional aspects of the disclosure will be set forth in portion in the description which follows and, in part, will be obvious from the description, or may be learned by practice of the disclosure

In accordance with one aspect of the present invention, an autonomous driving control apparatus may include an image acquirer configured to acquire an image of a road; an inputter through which a destination of the vehicle is input; a storage configured to store location information related to a preset location and image information corresponding to the preset location; a location receiver configured to receive a current location of the vehicle; and a controller configured to generate a route from the received current location to the destination, control driving of the vehicle based on route information related to the generated route and image information related to the acquired image, and reduce a driving speed of the vehicle when it is determined that the current location is the preset location based on the image information related to the acquired image and the stored image information.

The controller of the autonomous driving control apparatus in accordance with one aspect may determine whether a speed restriction section is present on a lane of the road based on the image information related to the acquired image, and when the speed restriction section is determined to be present, the controller may be configured to control a suspension of the vehicle to adjust a damping force of a damper of the suspension and a height of a vehicle body.

When it is determined that the preset location is an entry location of a tollgate, the controller of the autonomous driving control apparatus in accordance with one aspect may determine whether a travel lane is a toll ticket lane based on the image information related to the acquired image, and when the travel lane is determined to be the toll ticket lane, the controller may be configured to control an opening and closing device to open a window adjacent to a driver seat of the vehicle and control a suspension of the vehicle to adjust a height of a vehicle body.

The controller of the autonomous driving control apparatus in accordance with one aspect may control the suspension to start to adjust the height of the vehicle body at a location of the vehicle which is spaced a certain distance from a location of a toll ticket dispenser and a location of a toll booth.

The controller of the autonomous driving control apparatus in accordance with one aspect may determine whether a vehicle has passed through the tollgate based on the image information related to the acquired image, and when it is determined that the vehicle has passed through the tollgate, the controller may be configured to control the opening and closing device to close the window adjacent to the driver seat and control the suspension to return the height of the vehicle body to an original height thereof.

The controller of the autonomous driving control apparatus in accordance with one aspect may confirm a distance between the current location and the destination based on location information related to the received current location and location information related to the destination, and when the confirmed distance is determined to be a reference distance, the controller may perform a control to turn off an air conditioner, a radio, and an audio device in the vehicle.

When the current location is determined to be the destination, the controller of the autonomous driving control apparatus in accordance with one aspect may control an opening and closing device to open a window adjacent to a driver seat of the vehicle.

When the current location is determined to be the destination, the controller may release an automatic on/off function of an engine of the vehicle and an automatic on/off function of a brake of the vehicle.

In accordance with another aspect of the present invention, a vehicle may include a power device configured to apply a driving force to a wheel of the vehicle; a brake configured to apply a braking force to the wheel; an image acquirer configured to acquire an image of a road; an inputter through which a destination of the vehicle is input; a storage configured to store location information related to a preset location and image information corresponding to the preset location; a location receiver configured to receive a current location of the vehicle; and a controller configured to generate a route from the received current location to the destination during an autonomous driving mode, control driving of the vehicle based on route information related to the generated route and image information related to the acquired image, and control operation of at least one of the power device and the brake to reduce a driving speed when it is determined that the current location is the preset location based on the image information related to the acquired image and the stored image information.

The vehicle in accordance with another aspect may further include a suspension of the vehicle configured to mitigate a shock and a vibration to the vehicle from a road surface,

wherein the controller is configured to determine whether a speed restriction section is present on a lane of the road based on the image information related to the acquired image, and when the speed restriction section is determined to be present, the controller controls the suspension to adjust a damping force of a damper of the suspension and a height of a vehicle body.

The vehicle in accordance with another aspect may further include a suspension of the vehicle configured to mitigate a shock and a vibration to the vehicle from a road surface and an opening and closing device configured to open or close a window of a door of the vehicle, wherein, when it is determined that the preset location is an entry location of a tollgate, the controller is configured to determine whether a travel lane is a toll ticket lane based on the image information related to the acquired image, and when the travel lane is determined to be the toll ticket lane, the controller controls the opening and closing device to open a window adjacent to a driver seat of the vehicle and controls the suspension to adjust a height of a vehicle body.

The vehicle in accordance with another aspect may further include a suspension of the vehicle configured to mitigate a shock and a vibration to the vehicle from a road surface, wherein, during a manual driving mode of the vehicle, when it is determined that the preset location is an entry location of a tollgate, the controller is configured to determine whether a speed restriction section is present on a lane of the road based on the image information related to the acquired image, and when the speed restriction section is determined to be present, the controller controls the suspension to reduce a damping force of a damper of the suspension and raise a height of a vehicle body.

The vehicle in accordance with another aspect may further include an opening and closing device configured to open or close a window of a door of the vehicle, wherein, during the manual driving mode, the controller is configured to determine whether a travel lane is a toll ticket lane based on the image information related to the acquired image, and when the travel lane is determined to be the toll ticket lane, the controller controls the opening and closing device to open a window adjacent to a driver seat of the vehicle and controls the suspension to adjust the height of the vehicle body.

The controller of the vehicle in accordance with another aspect may control the suspension to start to adjust the height of the vehicle body at a location of the vehicle which is spaced a certain distance from a location of the tollgate.

The controller of the vehicle in accordance with another aspect may determine whether the vehicle has passed through the tollgate based on the image information related to the acquired image, and when it is determined that the vehicle has passed through the tollgate, the controller may be configured to control the opening and closing device to close the window adjacent to the driver seat and control the suspension to return the height of the vehicle body to an original height thereof.

The controller of the vehicle in accordance with another aspect may confirm a distance between the current location and the destination based on location information related to the received current location and location information related to the destination, and when the confirmed distance is determined to be a reference distance, the controller may perform a control to turn off an air conditioner, a radio, and an audio device in the vehicle.

The vehicle in accordance with another aspect may further include an opening and closing device configured to open or close a window of a door of the vehicle and an illumination detector configured to detect external illuminance, wherein, when the current location is determined to be the destination, the controller confirms the detected external illuminance, and, when the confirmed external illuminance is less than or equal to a reference illuminance, the controller controls the opening and closing device to open a window adjacent to a driver seat of the vehicle.

When the current location is determined to be the destination, the controller of the vehicle in accordance with another aspect may release an automatic on/off function of an engine and an automatic on/off function of the brake.

In accordance with another aspect of the present invention, a vehicle may include a power device configured to apply a driving force to a wheel of the vehicle; a brake configured to apply a braking force to the wheel; a suspension of the vehicle configured to mitigate a shock and a vibration to the vehicle from a road surface; an opening and closing device configured to open or close a window of a door of the vehicle; an image acquirer configured to acquire an image of a road; an inputter through which a destination of the vehicle is input; a storage configured to store entry location information related to a tollgate; a location receiver configured to receive a current location of the vehicle; a controller configured to generate a route from the received current location to the destination, control road guidance based on route information related to the generated route, determine whether a speed restriction section is present and a type of a lane of the vehicle based on image information related to the acquired image when the received current location is determined to be an entry location of the tollgate, control a damping force of the suspension to be reduced when the speed restriction section is determined to be present, and control the opening and closing device to open or close the window when the type of the lane of the vehicle is determined to be a toll ticket lane; and a display configured to display the generated route and road guidance information.

The vehicle in accordance with another aspect may further include an illumination detector configured to detect external illuminance, wherein the controller confirms a distance between the current location and the destination based on location information related to the received current location and location information related to the destination, when the confirmed distance is determined to be a reference distance, the controller performs a control to turn off an air conditioner, a radio, and an audio device in the vehicle, when the current location is determined to be the destination, the controller confirms the detected external illuminance, and when the confirmed external illuminance is less than or equal to a reference illuminance, the controller controls the opening and closing device to open a window adjacent to a driver seat of the vehicle.

In accordance with another aspect of the present invention, a method of controlling a vehicle may include, when a destination of the vehicle is received, generating a route to the destination; controlling road guidance based on route information related to the generated route; determining whether a current location of the vehicle is an entry location of a tollgate based on image information related to an image acquired by an image acquirer; when the current location is determined to be the entry location of the tollgate, determining whether a speed restriction section is present and a type of a lane of the vehicle based on the image information related to the acquired image; when the speed restriction section is present, controlling a suspension of the vehicle to reduce a damping force of the suspension and raise a height of a door of the vehicle; and when the type of the lane of the vehicle is determined to be a toll ticket lane, controlling an opening and closing device to open a window adjacent to a driver seat of the vehicle.

The method of controlling the vehicle in accordance with another aspect may further include, when a driving mode of the vehicle is an autonomous driving mode, controlling operation of at least one of a power device and a brake of the vehicle to reduce a driving speed of the vehicle at the entry location of the tollgate.

The method of controlling the vehicle in accordance with another aspect may further include confirming a distance between the current location and the destination based on location information related to the current location and location information related to the destination; when the confirmed distance is determined to be a reference distance, performing a control to turn off an air conditioner, a radio, and an audio device in the vehicle; when the current location is determined to be the destination, confirming detected illuminance; and when the confirmed external illuminance is less than or equal to a reference illuminance, controlling the opening and closing device to open the window adjacent to the driver seat.

The method of controlling the vehicle in accordance with another aspect may further include, when the type of the lane of the vehicle is the toll ticket lane, confirming a location of the tollgate based on the image information related to the image acquired by the image acquirer and controlling the suspension to start to adjust a height of a vehicle body at a location of the vehicle which is spaced a certain distance from the location of the tollgate.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an example diagram illustrating an external of a vehicle in accordance with an exemplary embodiment of the present invention;

FIG. 2 is an example diagram illustrating an internal of the vehicle in accordance with an exemplary embodiment of the present invention;

FIG. 3 is a block diagram illustrating a control configuration of a vehicle according to an exemplary embodiment of the present invention;

FIG. 4A and FIG. 4B are flowcharts of a method of controlling a vehicle according to an exemplary embodiment and are control flowcharts of the vehicle when the vehicle travels through a tollgate;

FIG. 5 and FIG. 6 are diagrams illustrating examples when the vehicle according to an exemplary embodiment travels in a high-pass lane.

FIG. 7 and FIG. 8 are diagrams illustrating examples when the vehicle according to an exemplary embodiment travels in a toll ticket lane; and

FIG. 9 is a control flowchart of a vehicle according to an exemplary embodiment and is a control flowchart of the vehicle when a preset location is a destination.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Like reference numerals refer to like elements throughout the specification. The exemplary embodiment does not describe all elements of embodiments, and common knowledge in the Field of the Invention to which the present invention pertains or the same descriptions of the exemplary embodiments will be omitted. The term “unit” may be implemented by hardware or software.

Throughout the present specification, when a portion is referred to as being “connected” to another part, the two parts may not only be directly connected but may also be indirectly connected, and an indirect connection includes a connection via a wireless communication network.

When a portion is referred to as “including” a component, other components are not excluded therefrom and may be further included unless specified otherwise.

An expression in the singular form includes the plural form unless explicitly stated otherwise.

Identification numbers of respective steps are used for convenience of description and do not describe a sequence of the respective steps. The respective steps may be conducted in a sequence different from that described unless a sequence is specified.

Hereinafter, embodiments of the present invention will be described with reference to the accompanying drawings.

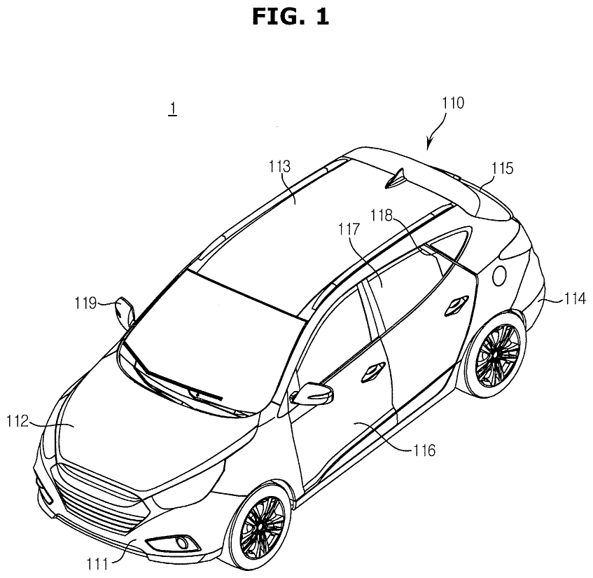

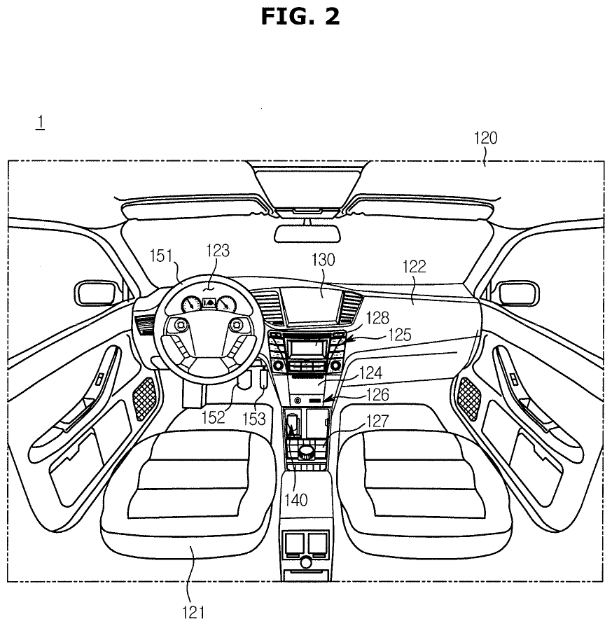

FIG. 1 is an example diagram illustrating an external of a vehicle including an autonomous driving control apparatus in accordance with an exemplary embodiment of the present invention. FIG. 2 is an example diagram illustrating an internal of the vehicle including the autonomous driving control apparatus in accordance with an exemplary embodiment of the present invention.

A vehicle 1 includes a body having an internal and an external and a chassis, which is the rest of the vehicle except for the body and in which mechanisms necessary for driving are disposed.

As shown in FIG. 1, the external 110 of the body includes a front panel 111, a bonnet 112, a roof panel 113, a rear panel 114, a trunk 115, front, rear, left, and right doors 116, and a window 117 provided in each of the front, rear, right, and left doors 116 to be openable or closable.

The external of the body further includes fillers 118 provided in boundaries between the front panel, the bonnet, the roof panel, the rear panel, the trunk, and windows of the front, rear, left, and right doors, and side mirrors 119 configured to provide a field of vision in the rear direction of the vehicle 1 to a driver.

As shown in FIG. 2, the internal 120 of the body includes seats 121 on which a passenger sits, a dashboard 122, a gauge board (cluster) 123 disposed on the dashboard, and a center fascia 124 in which an air outlet and a control panel of an air conditioner, a radio, and an audio device are disposed, wherein a tachometer, a speedometer, a coolant thermometer, a fuel gauge, a turn indicator, a high beam indicator light, a warning light, a seat belt warning light, an odometer, a traveling recorder, an automatic transmission selector lever indicator, a door of the vehicle open warning light, an engine oil warning light, a fuel shortage warning light, and the like are disposed on the gauge board 123.

The cluster 123 may further include a display portion configured to display traveling information and failure information related to the vehicle. Here, the traveling information may include fuel mileage information, distance to empty (DTE) information, a total travel distance, and a driving mode. The failure information may include tire air pressure abnormality information and the like.

A head unit 125 configured to control the radio, the audio device, and the air conditioner, a multi-terminal 126, and the like may be disposed in the center fascia 124.

Here, the multi-terminal 126 may be disposed at a location adjacent to the head unit 125, may include a Universal Serial Bus (USB) port and an auxiliary (AUX) terminal, and may further include a secure digital (SD) slot.

The multi-terminal 126 may also communicate with a user terminal through the USB port. Here, the user terminal may be a mobile communication device and may include a smart phone, a notebook, a tablet personal computer (PC), and a wearable device.

The vehicle 1 may further include an inputter 127 configured to receive operation commands for various functions.

The inputter 127 may be provided in the head unit 125 and the center fascia 124 and may include at least one physical button such as an operation on-off button with various functions and a button for changing setting values of various functions.

The inputter 127 may include a touch panel integrally mounted on a display portion of a vehicle terminal 130. The inputter 127 may receive location information related to a button displayed on the display portion of the vehicle terminal 130

The inputter 127 may further include a jog dial or a touch pad, which is configured to input a movement command, a selection command, and the like of a cursor displayed on the display portion of the vehicle terminal 130.

Here, the jog dial or the touch pad may be provided in the center fascia or the like.

The vehicle 1 may further include a display 128 configured to display information on a function which is being executed and information input by a user.

The display 128 may display selection information and execution information related to an auto hold function, selection information and execution information related to an autonomous driving mode, selection information and execution information related to an idle stop and go function, selection information and execution information related to a highway driving mode, and the like.

A display 128 may include a plasma display penal, a liquid crystal display (LCD) panel, an electro luminescence (EL) panel, an electrophoretic display (EPD) panel, an electrochromic display (ECD) panel, a light-emitting diode (LED) panel, an organic light-emitting diode (OLED) panel, or the like, but the present invention is not limited thereto.

The vehicle may further include the vehicle terminal 130 configured to receive pieces of information on a radio mode, an audio mode, a video mode, a digital multimedia broadcasting (DMB) mode, a navigation mode, and an autonomous driving mode and display information on executing modes.

During the autonomous driving, the vehicle terminal 130 may display images in front, rear, left, and right directions and may display map information and road guidance information by interworking with the navigation mode.

The vehicle terminal 130 may be disposed on the dashboard as a mounted type or disposed in the center fascia as an embedded type.

The display portion of the terminal 130 may display information on a function which is being executed and information input by a user.

The vehicle 1 further includes a shift lever 140 provided in the center fascia 124 and configured to receive an operation location and a parking button (i.e., an electric parking brake (EPB) button) located around the shift lever 140 or in the head unit 125 and configured to receive an operation command of an electric parking brake device.

The vehicle 1 may include a steering wheel 151 of a steering device configured to adjust a traveling direction thereof, a brake pedal 152 pressed by a user according to a braking intention of the user, and an accelerator pedal 153 pressed by the user according to an accelerating intention of the user.

The vehicle may include a brake 161 configured to generate a braking force of the vehicle, a suspension of the vehicle 162 configured to adjust damping of the vehicle, an opening and closing device 163 configured to open or close the window 117 provided in the door of the vehicle by moving the window 117, an engine controller 164 configured to automatically turn on or off an engine 164a, a steering device 165 configured to change a driving direction of the vehicle, an air conditioner 166 configured to adjust a temperature inside the vehicle, and a radio 167 configured to output a radio broadcast.

The vehicle may further include an audio device configured to output sound.

Here, a power device may include a power generation device configured to generate power and a power transmission device configured to transmit the generated power to the wheel.

The power generation device may include at least one of an engine and a motor which apply a driving force to the wheel.

The brake 161 may perform an auto hold function.

Here, the auto hold function is a function of holding the wheel such that the vehicle is not suddenly accelerated by maintaining a braking force although pressure applied to the brake pedal is released when the vehicle is temporarily stopped (i.e., waits for a signal) in a state in which the shift lever is located at a drive stage (D stage). When the accelerator pedal is pressed, the auto hold function is released. Furthermore, the auto hold function is a function of applying a braking force to the wheel such that the vehicle is not pushed on a road with a certain gradient or more.

The suspension 162 is a device which fixes the wheel to the chassis of the vehicle and mitigates a shock and a vibration to the vehicle from a road surface. The suspension 162 protects the body by raising a height of the vehicle on a road with an uneven road surface and increases driving stability by lowering the height of the vehicle to reduce air resistance on a high-speed road such as a highway.

The suspension 162 decreases a damping force of a damper of the suspension when a road surface is uneven and increases the damping force of the damper when the road surface is even.

Furthermore, the suspension 162 increases the damping force when a driving speed is high, decreases the damping force when the driving speed is low, increases the damping force on a curvy road, decreases the damping force on a straight road, decreases a damping force of a front damper and increases a damping force of a rear damper during under-steering, and increases the damping force of the front damper and decreases the damping force of the rear damper during over-steering.

The suspension 162 gives a driver a rigid feel when the damping force of the damper is increased and gives the driver a smooth feel when the damping force of the damper is lowered.

Types of the suspension include a hydraulic type and a pneumatic type.

The engine controller 164 turns the engine on or off. The engine controller 164 performs an idle stop and go (ISG) function.

Here, the ISG function is a function of automatically turning the engine off when the vehicle is stopped for waiting for a signal, releasing pressure applied to the brake pedal when the vehicle turns off, or automatically turning on the engine (i.e., starting the engine) when pressure is applied to the accelerator pedal or when the shift lever is moved to a D stage.

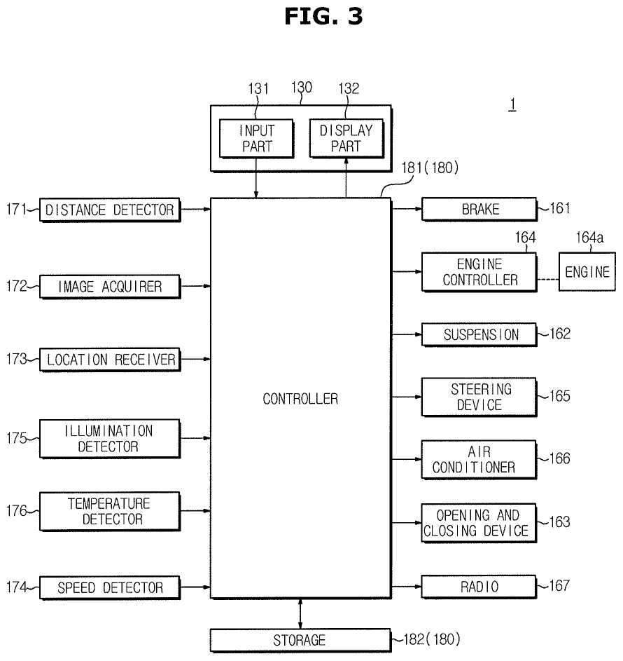

FIG. 3 is a block diagram illustrating a control configuration of a vehicle according to an exemplary embodiment of the present invention. A vehicle 1 includes various driving devices 161, 162, 164, and 165 for driving the vehicle and additional devices 163, 166, and 167 for user convenience. The vehicle 1 includes a terminal 130, a distance detector 171, an image acquirer 172, a location receiver 173, a speed detector 174, an illumination detector 175, a temperature detector 176, a controller 181, and a storage 182. The controller 181 and the storage 182 may form an autonomous driving control apparatus 180 for autonomous driving of the vehicle.

Various driving devices for driving the vehicle may include a brake 161, a suspension of the vehicle 162, an engine controller 164, and a steering device 165. The additional devices for user convenience may include an opening and closing device 163, an air conditioner 166, and a radio 167.

Descriptions of the driving devices and the additional devices will be omitted.

The terminal 130 receives pieces of information on an audio function, a video function, a DMB function, a navigation mode, and an autonomous driving mode and displays operation information on a function or a mode which is being executed.

The autonomous driving mode of the exemplary embodiment has a highway driving assist (HDA) function of allowing the vehicle to automatically travel only when a location of the vehicle is a highway.

When a driving mode is the autonomous driving mode, the terminal 130 may display images in front, rear, left, and right directions and may display map information and road guidance information by interworking with the navigation mode.

The terminal 130 may include an input portion 131 and a display portion 132. The input portion of the terminal 130 may be a touch panel, and the display portion thereof may be a display panel.

The terminal 130 may be provided as a touch screen in which the touch panel and the display panel are integrated.

Furthermore, the terminal 130 may include only the display panel, which is the display portion. In the instant case, the terminal 130 may receive operation information and an operation command through an inputter 127 provided in a center fascia of the vehicle.

The input portion 131 of the terminal receives a selection command of the autonomous driving mode. Furthermore, the input portion 131 of the terminal may receive a selection command of a manual driving mode in which the vehicle travels based on operation information related to a driver.

The input portion 131 of the terminal may receive a selection command of the navigation mode and a destination.

The input portion 131 of the terminal may receive a selection command and a release command of an auto hold function, an ISG function, and a highway driving mode.

The display portion 132 of the terminal may also display information on execution and release of the autonomous driving mode and information on execution and release of the highway driving mode.

The display portion 132 of the terminal may also display map information and display the map information and road guidance information with which a route is matched.

Furthermore, the terminal 130 may communicate with the controller 181 configured to control the navigation mode and the autonomous driving mode and may perform a display operation based on a control command of the controller 181, which is received through communication.

The distance detector 171 detects distances to other surrounding vehicles and obstacles. The distance detector 171 may be provided at each of a front, a back, a left, and a right of an external of the vehicle.

The distance detector 171 includes a light detection and ranging (LiDAR) sensor.

The LiDAR sensor is a non-contact type distance detection sensor using a laser radar principle.

The LiDAR sensor may include a transmitter configured to transmit a laser and a receiver configured to receive a laser reflected on a surface of an object which is present within a sensor range.

Here, the laser may be a single laser pulse.

The distance detector 171 may include an ultrasonic sensor or a radar sensor.

The ultrasonic sensor generates ultrasonic waves for a certain time and then detects a signal reflected on an object.

The ultrasonic sensor may be used to determine the presence or absence of an obstacle such as a pedestrian within a short range.

The radar sensor is a device which detects a location of an object by use of a reflected wave generated by emission radiation of a radio wave when transmission and reception are performed in the same place.

To prevent a difficulty in distinguishing a transmitted radio wave and a received radio wave due to the transmitted radio wave and the received radio wave overlapping each other, the radar sensor utilizes a Doppler effect, changes a frequency of the transmitted radio wave according to a time, or outputs a pulse wave as the transmitted radio wave.

For reference, the LiDAR sensor has higher detection accuracy in a lateral direction as compared with a radio detecting and ranging (RaDAR) sensor, improving accuracy of determining whether a path is present ahead.

The image acquirer 172 acquires an image of a road and transmits the acquired image to the controller 181. Here, the image of the road may be an image of a road in a forward direction with respect to a driving direction of the vehicle.

The image acquirer 172 may be a camera and may include a charged coupled device (CCD) or complementary metal-oxide semiconductor (CMOS) image sensor.

The image acquirer 172 may be mounted on the front of a windshield glass, on a window glass inside the vehicle, in a rear view mirror inside the vehicle, and in a roof panel 113 to be exposed to the outside.

The location receiver 173 receives a location of the vehicle.

The location receiver 173 may include a global positioning system (GPS) receiver configured to communicate with a plurality of satellites to determine the location of the vehicle.

The speed detector 174 detects a driving speed of the vehicle.

The speed detector 174 may be a wheel speed sensor mounted on each of front, rear, left and right wheels, or an acceleration sensor configured to detect an acceleration of the vehicle.

Furthermore, the vehicle may further include an angular speed detector configured to detect an angular speed of a steering wheel for detecting a steering angle of the vehicle and a yaw rate detector configured to detect a yaw moment of the vehicle.

The illumination detector 175 detects external illuminance of the vehicle.

The temperature detector 176 detects an external of the vehicle. Furthermore, the vehicle may further include an internal temperature detector configured to detect an internal temperature of the vehicle.

The controller 181 is provided in the vehicle and controls various driving devices and additional devices provided in the vehicle.

The controller 181 may be provided in the autonomous driving control apparatus 180 for autonomous driving.

The autonomous driving control apparatus 180 controls autonomous driving of the vehicle based on input information related to the inputter, image information related to the image acquirer 172, detection information related to the distance detector 171, detection information related to the speed detector 174, and location information related to the location receiver 173.

The autonomous driving control apparatus 180 may be a driving control apparatus having an HDA function of performing autonomous driving when a current location of the vehicle of the vehicle is a highway and releasing an autonomous driving mode when the current location of the vehicle is a road which is not a highway.

The autonomous driving control apparatus 180 may further include the storage 182 in addition to the controller 181 and may further include a communicator configured to receive information from the image acquirer 172, the distance detector 171, the location receiver 173, and the speed detector 174.

The communicator may include at least one component configured for communicating with various devices in the vehicle, and for example, may include at least one of a short-range communication module, a wired communication module, and a wireless communication module.

When a selection signal of a navigation mode selected through the input portion 131 of the terminal is received, the controller 181 confirms a current location of the vehicle received by the location receiver 173, confirms a destination of the vehicle selected through the input portion of the terminal, confirms map information stored in the storage 182, searches for a route from the current location to the destination, matches the found route to a map, and displays the map, to which the route is matched, on the display portion 132 of the terminal.

When a selection signal of an autonomous driving mode is received, the controller 181 activates operations of the image acquirer 172 and the distance detector 171, performs interworking with a navigation mode, and controls driving of various driving devices based on navigation information, image information, distance information, and speed information to allow the vehicle to autonomously travel from the current location to the destination.

During the autonomous driving mode, the controller 181 confirms a location of the other vehicle travelling in a lane in a left direction or a right direction of a lane of the vehicle based on distance information to an obstacle detected by the distance detector 171, confirms a distance to the other vehicle corresponding to the confirmed location of the other vehicle, and adjusts a speed of the vehicle based on the confirmed distance of the other vehicle.

When image information related to a road is received during the autonomous driving mode, the controller 181 performs image processing, recognizes a lane of the road, and recognizes a lane in which the vehicle travels based on location information related to the recognized lane.

During the autonomous driving mode, the controller 181 controls a driving (steering) direction of the vehicle to maintain or change a lane based on a distance to the other vehicle, a current location of the vehicle, a recognized lane, a recognized carriageway, and a found route.

During the autonomous driving mode, the controller 181 may also display images in front, back, left and right directions of the vehicle acquired by the image acquirer 172 and may also display map information and road guidance information, to which a route is matched, by interworking with the navigation mode.

Here, navigation information includes destination information and map information and further includes a name of a road, location information related to the road, a kind of the road, and a route number of the road in a map.

Furthermore, when a highway driving mode is selected, the controller 181 determines whether the vehicle has entered a highway based on the navigation information and the location information. When it is determined that the vehicle has entered the highway, the controller 181 controls autonomous driving on the highway using the HDA function. When it is determined that the vehicle has exited the highway, the controller 181 exits the highway driving mode.

Furthermore, when the autonomous driving mode is released, the controller 181 performs a manual driving mode. That is, during the manual driving mode, the controller 181 may adjust a speed of the vehicle by controlling a power device and a brake based on operation information related to a brake pedal and operation information related to an accelerator pedal, which are operated by a driver. Furthermore, the controller 181 may adjust a driving direction of the vehicle by controlling a steering device based on steering information related to the steering wheel operated by the driver.

When image information acquired by the image acquirer is received, the controller 181 may also process and recognize an image to recognize a toll gate, a high pass lane, and a toll ticket lane and recognize a speed restriction section.

The controller 181 may also recognize a speed restriction section, a school zone, and a curvy road based on navigation information.

During the autonomous driving mode, the controller 181 compares a current location of the vehicle with a preset location. When it is determined that the current location is the preset location, the controller 181 reduces revolutions per minute (RPM) of an engine or controls braking of the brake to reduce a driving speed.

When the driving speed is reduced, the controller 181 may check a speed limit corresponding to a characteristic of a location and control the driving speed to be reduced based on the checked speed limit.

Here, the speed limit corresponding to the characteristic of the location may include a speed limit of a tollgate entry section and may further include a speed limit on a curvy road, a speed limit on a speed bump, and a speed limit in a school zone.

During the autonomous driving mode or the manual driving mode, the controller 181 may control operation of the suspension to adjust a height of the vehicle body and a damping force based on a surface state of a road.

That is, when the surface state is an uneven state or a speed bump is present, the controller 181 controls the suspension to reduce a damping force of a damper. When the surface state is an even state, the controller 181 controls the suspension to increase the damping force of the damper.

When the vehicle travels on the toll ticket lane in the manual driving mode, the controller 181 controls the opening and closing device to open a window adjacent to a driver seat of the vehicle and controls the suspension to adjust the height of the vehicle body based on a height of a toll ticket dispenser.

The controller 181 confirms a distance between a current location of the vehicle and a destination. When it is determined that the distance between the current location and the destination is a reference distance, the controller 181 controls the radio to be turned off, controls an audio device to be turned off, and controls the operation of the suspension to adjust the height of the vehicle body.

When it is determined that the current location is spaced the reference distance from the destination, i.e., the current location is near the destination, the controller 181 may control at least one of the air conditioner, the radio, the audio device, and the suspension.

The controller 181 compares location information related to the current location with location information related to the destination. When it is determined that the current location is the destination, the controller 181 confirms illuminance detected by the illumination detector. When it is determined that the confirmed external illuminance is less than or equal to a reference illuminance, the controller 181 controls the opening and closing device to open a window.

When it is determined that the current location is the destination, the controller 181 confirms the illuminance detected by the illumination detector and a temperature detected by the temperature detector. When the confirmed external illuminance is less than or equal to the reference illuminance and the confirmed temperature is greater than or equal to reference temperature, the controller 181 controls operation of the opening and closing device to open the window.

Furthermore, a setting of window opening during parking according to an external temperature may be selected or released by a user.

When it is determined that the current location is the destination, the controller 181 determines whether the auto hold function and the ISG function are being performed. When it is determined that the auto hold function and the ISG function are being performed, the controller 181 may release the auto hold function and may also release the ISG function.

When it is determined that the current location is the destination, the controller 181 may also control operation of the steering device to set a turning radius and a gear ratio that facilitate parking.

In the case of a vehicle including a rear wheel steering (RWS) device, the controller 181 controls the RWS device such that the vehicle has a turning radius that facilitates parking.

In the case of a vehicle including an active front steering (AFS) device, the controller 181 sets a steering ratio of the AFS device to be a gear ratio that facilitates parking.

Here, the turning radius and the gear ratio may be set by a user.

The controller 181 may be a central processing unit (CPU), a main control unit (MCU), or a processor.

The controller 181 may be implemented as a memory configured to store data on an algorithm for controlling operations of components in the vehicle or store data on a program for reproducing an algorithm, and a processor configured to execute such an operation using the data stored in the memory. In the instant case, each of the memory and the processor may be implemented as a separate chip. Alternatively, the memory and the processor may be implemented as a single chip.

The storage 182 stores map information, a name of a road, a kind of the road, a route number of the road, and location information related to the road in a map and stores location information and image information related to a preset location.

The preset location may be a tollgate, a curvy road with a curvature greater than or equal to a preset curvature, a speed bump, or a school zone.

The storage 182 may store location information related to a destination of the vehicle and may also store a reference distance for determining the vicinity of the destination.

The storage 182 may be implemented as at least one of a non-volatile memory device such as a cache memory, a read-only memory (ROM), a programmable ROM (EPROM), an erasable programmable ROM (EPROM), an electrically erasable programmable ROM (EEPROM), or a flash memory, a volatile memory device such as a random access memory (RAM), and a storage medium such as a hard disk drive (HDD) or a CD-ROM, but the present invention is not limited thereto. The storage may be a memory implemented as a chip separate from the processor described above in connection with the controller and may be implemented as a single chip together with the processor.

The storage 182 stores reference illuminance and reference temperature.

The storage 182 may also store a turning radius of the RWS device or a gear ratio of the AFS device.

At least one component may be added or removed according to performances of the components of the vehicle shown in FIG. 3. Furthermore, it will be obvious to one of ordinary skill in the art that mutual locations of the components may be changed according to performance or a structure of a system.

Some components illustrated in FIG. 3 may be software and/or hardware components, such as field programmable gate arrays (FPGAs) and application specific integrated circuits (ASICs).

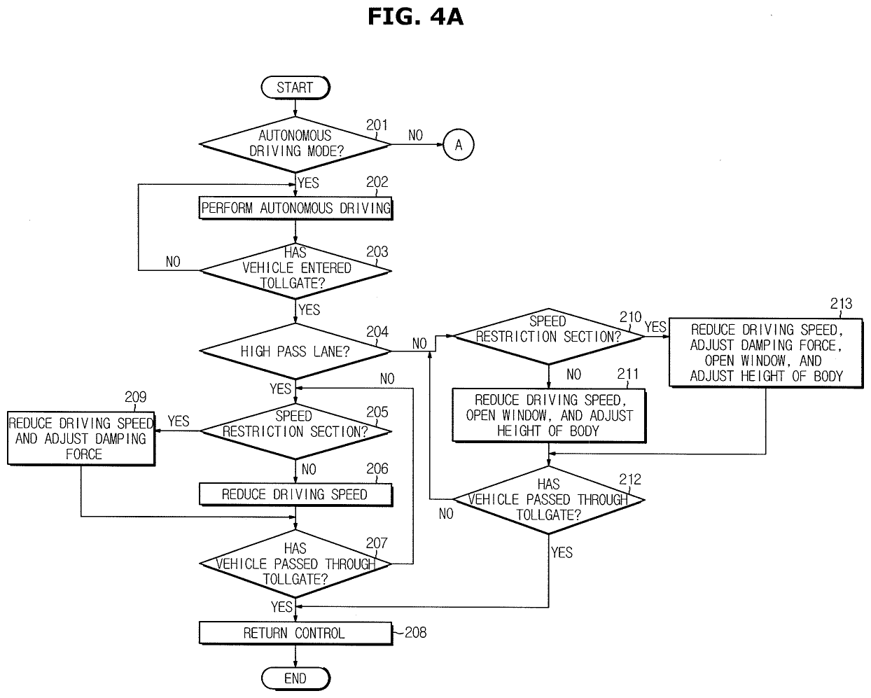

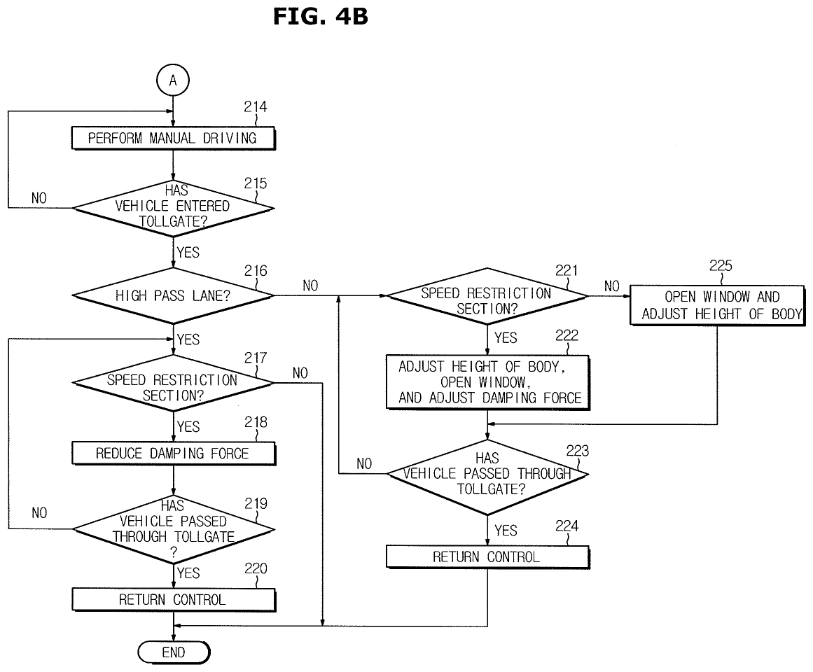

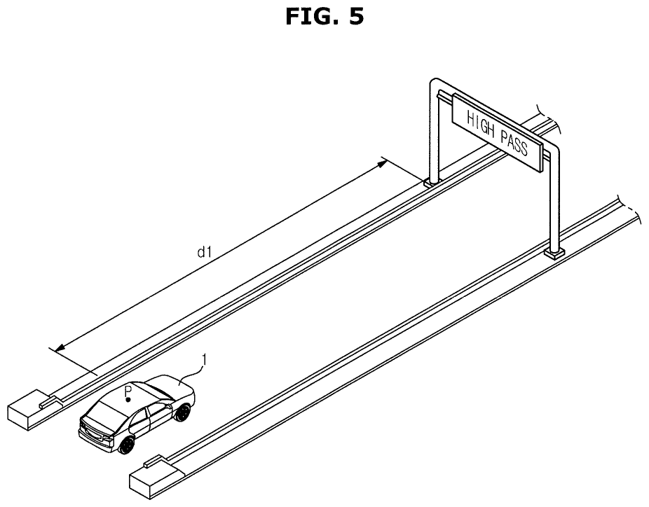

FIG. 4A and FIG. 4B are flowcharts of a method of controlling a vehicle according to an exemplary embodiment of the present invention. Descriptions will be made with reference to FIGS. 5 to 8.

FIG. 4A is a control flowchart of a vehicle in an autonomous driving mode, and FIG. 4B is a control flowchart of the vehicle in a manual driving mode.

As shown in FIG. 4A, when the autonomous driving mode is selected through an inputter 127 provided in a center fascia or an input portion 131 of the terminal (201), the vehicle performs interworking with a navigation mode.

The vehicle confirms a current location of the vehicle received by a location receiver 173 and confirms a destination of the vehicle input through the inputter 127 provided in the center fascia or the input portion 131 of the terminal. The vehicle searches for a route from the current location to the destination, matches the found route to a map, and displays the map on the display portion 132 of the terminal.

The vehicle performs autonomous driving from the current location to the destination based on map information, route information, and current location information (202)

during the autonomous driving mode, the vehicle confirms a location of the other vehicle travelling in a lane in a left direction or a right direction of a lane of the vehicle based on distance information to an obstacle detected by a distance detector 171, confirms a distance to the other vehicle corresponding to the confirmed location of the other vehicle, and adjusts a speed of the vehicle based on the confirmed distance of the other vehicle.

During the autonomous driving mode, the vehicle recognizes a lane of a road based on an image of the road acquired by an image acquirer 172 and recognizes a lane in which the vehicle travels based on location information related to the recognized lane.

During the autonomous driving mode, the vehicle controls a driving (steering) direction of the vehicle to maintain or change a lane based on the distance to the other vehicle, the current location, the recognized lane, a recognized carriageway, and the found route.

While the vehicle travels in the autonomous driving mode, the vehicle determines whether the current location is a preset location.

The determining of whether the current location is the preset location may include determining whether the current location is an entry location of a tollgate, an entry location of a curvy road, an entry location of a school zone, or an entry location of a speed restriction section.

An example in which the current location is the entry location of the tollgate will be described in an exemplary embodiment of the present invention.

The determining of whether the current location is the preset location may include comparing the current location received by the location receiver with the preset location stored in a storage and determining whether the two locations are the same.

Furthermore, the determining of whether the current location is the preset location may include determining whether an image of the tollgate is present in an image acquired by the image acquirer, and when the image of the tollgate is present in the acquired image, determining that the current location is the preset location.

When it is determined that the current location is the entry location of the tollgate (203), the vehicle determines whether a kind of a lane in which the vehicle is traveling is a high pass lane or a toll ticket lane.

Here, the entry location of the tollgate may be a location which is spaced the preset distance from the tollgate or may be an entry location stored in the storage.

The determining of whether the lane, in which the vehicle is traveling, is the high pass lane may include determining whether an image of the phrase “high pass” is present in the image acquired by the image acquirer and determining whether the phrase “toll ticket” is present in the image acquired by the image acquirer.

When it is determined that the vehicle is traveling in the high pass lane (204), the vehicle determines whether a speed restriction section is present in the high pass lane based on the image acquired by the image acquirer (205).

Furthermore, the vehicle may determine whether the speed restriction section is present in the high pass lane based on navigation information

As shown in FIG. 5, when the current location is an entry location P of the tollgate, the vehicle determines whether a lane of the vehicle is a high pass lane and whether a speed restriction section is present on a lane of the road based on the image acquired by the image acquirer. When it is determined that the lane of the vehicle is the high pass section and the speed restriction section is not present, the vehicle reduces a driving speed (206).

The vehicle may also obtain a distance between the tollgate and the vehicle based on location information related to the tollgate and location information related to the vehicle and may start deceleration when the obtained distance is greater than or equal to a certain distance d1. In the instant case, the vehicle reduces an RPM of an engine or generates a braking force using a brake to reduce a driving speed to a speed limit when the vehicle passes through the tollgate.

The vehicle compares current location information with the location information related to the tollgate to determine whether the vehicle has passed through the tollgate (207). When it is determined that the vehicle has passed through the tollgate, the vehicle performs a return control (208). That is, the vehicle increases the RPM of the engine to increase the driving speed to a set speed of the autonomous driving mode.

The vehicle may also determine whether the vehicle has passed through the tollgate based on image information related to the image acquired by the image acquirer.

Furthermore, when the driving speed is increased, the vehicle increases the RPM of the engine based on a distance to the other vehicle ahead and a speed of the other vehicle.

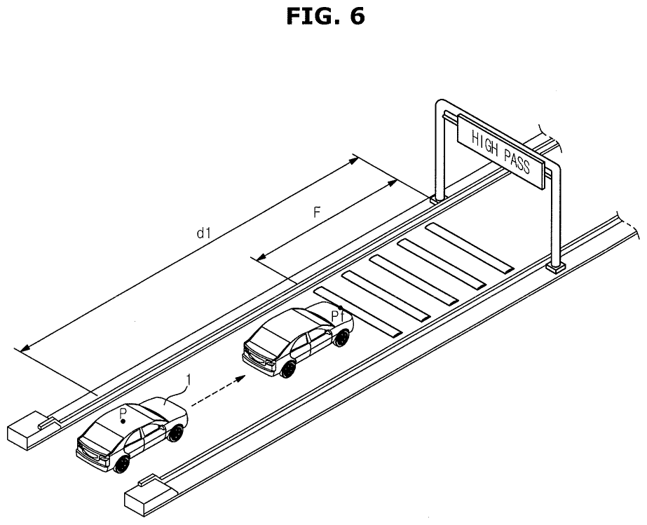

As shown in FIG. 6, when it is determined that a lane of the vehicle is the high pass lane and a speed restriction section F is present in the lane of the vehicle, the vehicle reduces a driving speed and a damping force of a damper of the suspension (209).

The vehicle obtains a distance between the tollgate and the vehicle based on location information related to the tollgate and location information related to the vehicle and starts deceleration when the obtained distance is a certain distance d1. When it is determined that the current location is a start location Pf of the speed restriction section based on the current location information and location information related to the speed restriction section, the vehicle reduces the damping force of the damper.

In the instant case, the vehicle reduces the RPM of the engine or generates the braking force using the brake to reduce a driving speed to a speed limit when the vehicle passes through the tollgate.

Furthermore, before the vehicle travels in the speed restriction section, the vehicle may adjust a height of the vehicle body through a control of the suspension to raise the height of the vehicle body and may travel in the speed restriction section.

The vehicle compares current location information with the location information related to the tollgate to determine whether the vehicle has passed through the tollgate (207). When it is determined that the vehicle has passed through the tollgate, the vehicle performs the return control (208). That is, the vehicle increases the RPM of the engine and increases the damping force of the damper to a reference damping force to increase the driving speed to the set speed of the autonomous driving mode.

Furthermore, when the height of the vehicle body is adjusted due to the speed restriction section, after the vehicle passes through the tollgate, the vehicle may also adjust the height of the vehicle body to a reference height.

As described above, when the vehicle travels in the high pass lane of the tollgate, the vehicle may control the suspension (electronic controlled suspension (ECS) device) according to a driving situation while reducing the driving speed.

When it is determined that a lane of the vehicle is the toll ticket lane, the vehicle determines whether a speed restriction section is present in the toll ticket lane based on an image acquired by the image acquirer (210).

Furthermore, the vehicle may determine whether the speed restriction section is present in the toll ticket lane based on navigation information.

When the vehicle is at an entry location of the tollgate, the vehicle determines whether a lane of the vehicle is the toll ticket lane and whether the speed restriction section is present based on the image acquired by the image acquirer. When it is determined that the lane of the vehicle is the toll ticket lane and the speed restriction section is not present in the lane of the vehicle, the vehicle reduces a driving speed, opens a window provided in a door of the vehicle adjacent to a driver seat of the vehicle, and adjusts the height of the vehicle body based on a height of a toll ticket dispenser (211).

In the instant case, the vehicle reduces the RPM of the engine or generates the braking force using the brake to reduce a driving speed to a speed limit when the vehicle passes through the tollgate.

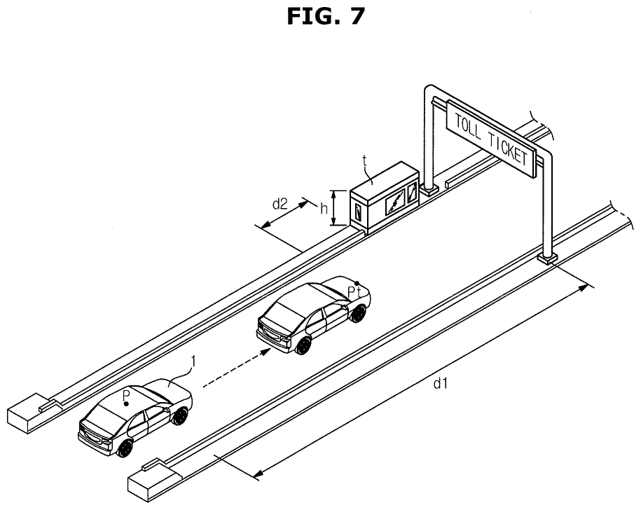

As shown in FIG. 7, the vehicle may also obtain a distance between the tollgate and the vehicle based on location information related to the tollgate and location information related to the vehicle and may start deceleration when the obtained distance is greater than or equal to a certain distance d1. In the instant case, the vehicle reduces the RPM of the engine or generates the braking force using the brake to reduce a driving speed to a speed limit when the vehicle passes through the tollgate.

The vehicle determines whether the vehicle is adjacent to a toll ticket dispenser based on the location information related to the tollgate and the location information related to the vehicle. When it is determined that a location of the vehicle is adjacent to the toll ticket dispenser, the vehicle opens the window provided in the door adjacent to the driver seat and adjusts the height of the vehicle body based on a height h of a toll ticket dispenser.

Here, the adjusting of the body based on the height of the toll ticket dispenser may include acquiring an image of the till ticket dispenser from an image acquired by the image acquirer, estimating the height of the toll ticket dispenser in the acquired image, and adjusting the height of the vehicle body based on the estimated height of the toll ticket dispenser.

Furthermore, the vehicle determines whether the vehicle is adjacent to a toll booth based on the location information related to the tollgate and the location information related to the vehicle. When it is determined that a location of the vehicle is adjacent to the toll booth, the vehicle opens the window provided in the door adjacent to the driver seat and adjusts the height of the vehicle body based on a height of the toll booth.

When the height of the vehicle body is adjusted, the vehicle starts to adjust the height of the vehicle body at a location Pt which is spaced the certain distance d2 from a location t of the toll ticket dispenser or the toll booth.

This is because it is taken into account that adjusting the height of the vehicle body by 30 mm takes about 10 seconds.

Furthermore, the vehicle determines whether a lane in which the vehicle is traveling is the high pass lane or the toll ticket lane based on whether the vehicle is configured for communicating with a high pass terminal of the tollgate. When it is determined that the lane is the toll ticket lane, the vehicle may open the window provided in the door adjacent to the driver seat and may adjust the height of the vehicle body.

The vehicle compares current location information with the location information related to the tollgate to determine whether the vehicle has passed through the tollgate (212). When it is determined that the vehicle has passed through the tollgate, the vehicle performs the return control (208). That is, the vehicle increases the RPM of the engine to increase the driving speed to the set speed of the autonomous driving mode, closes the window provided in the door adjacent to the driver seat, and adjusts the height of the vehicle body to the reference height.

Furthermore, when the driving speed is increased, the vehicle increases the RPM of the engine based on a distance to the other vehicle ahead and a speed of the other vehicle.

Here, the reference height may be a height before the height of the vehicle body is raised and may be a height before the vehicle enters a speed restriction section.

When a lane of the vehicle is the toll ticket lane and a speed restriction section F is present in the lane of the vehicle, the vehicle reduces the driving speed and the damping force of the damper, opens the window provided in the door adjacent to the driver seat, and adjusts the height of the vehicle body based on the height of the toll ticket dispenser (213).

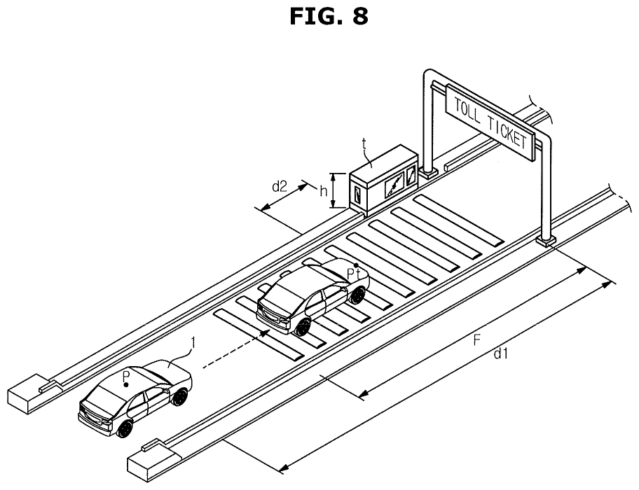

As shown in FIG. 8, the vehicle may obtain a distance between the tollgate and the vehicle based on location information related to the tollgate and location information related to the vehicle. When the obtained distance is a certain distance d1, the vehicle starts decelerating. When a location of the vehicle is a start location P of a speed restriction section, the vehicle may also reduce the damping force of the damper. In the instant case, the vehicle reduces the RPM of the engine or generates the braking force using the brake to reduce a driving speed to a speed limit when the vehicle passes through the tollgate.

The vehicle determines whether the vehicle is adjacent to a toll ticket dispenser based on the location information related to the tollgate and the location information related to the vehicle. When it is determined that a location of the vehicle is adjacent to a location Pt of the toll ticket dispenser, the vehicle opens the window provided in the door adjacent to the driver seat and adjusts the height of the vehicle body based on the height h of the toll ticket dispenser.

Here, the adjusting of the height of the vehicle body based on the height of toll ticket dispenser may include acquiring an image of the till ticket dispenser from an image acquired by the image acquirer, estimating the height of the toll ticket dispenser in the acquired image, and adjusting the height of the vehicle body based on the estimated height of the toll ticket dispenser.

Furthermore, the vehicle determines whether the vehicle is adjacent to the toll booth based on the location information related to the tollgate and the location information related to the vehicle. When it is determined that a location of the vehicle is adjacent to the toll booth, the vehicle opens the window provided in the door adjacent to the driver seat and adjusts the height of the vehicle body based on the height of the toll booth.

When the height of the vehicle body is adjusted, the vehicle starts to adjust the height of the vehicle body at the position Pt which is spaced a certain distance d2 from the location t of the toll ticket dispenser or the toll booth.

This is because it is taken into account that adjusting the height of the vehicle body by 30 mm takes about 10 seconds.

Furthermore, before the vehicle travels in the speed restriction section, the vehicle may adjust the height of the vehicle body through a control of the suspension to raise the height of the vehicle body and then pass through the speed restriction section. Furthermore, when the location of the vehicle is adjacent to the toll ticket dispenser, the vehicle may adjust the height of the vehicle body to be greater than or equal to the height of the toll ticket dispenser.

Furthermore, before the vehicle travels in the speed restriction section, the vehicle may adjust the height of the vehicle body through a control of the suspension to raise the height of the vehicle body and then pass through the speed restriction section. Furthermore, when the location of the vehicle is adjacent to the toll ticket dispenser, the vehicle may adjust the height of the vehicle body to be greater than or equal to the height of the toll ticket dispenser.

The vehicle compares current location information with the location information related to the tollgate to determine whether the vehicle has passed through the tollgate (212). When it is determined that the vehicle has passed through the tollgate, the vehicle performs the return control (208). That is, the vehicle increases the RPM of the engine to increase the driving speed to the set speed of the autonomous driving mode, closes the window provided in the door adjacent to the driver seat, and adjusts the height of the vehicle body to the reference height to increase the damping force of the damper.

Furthermore, when the driving speed is increased, the vehicle increases the RPM of the engine based on a distance to the other vehicle ahead and a speed of the other vehicle.

As described above, when the vehicle travels in the toll ticket pass lane of the tollgate, the vehicle may reduce the driving speed to control the suspension (ECS device) and the window provided in the door adjacent to the driver seat such that toll ticket issuing and toll payment are easily performed.

As shown in FIG. 4B, when the autonomous driving mode is not selected, the vehicle performs the manual driving mode by adjusting a driving speed based on pressing information related to a brake pedal and an accelerator pedal and controlling a driving direction of the vehicle by controlling a steering device based on steering information related to a steering wheel operated by a driver (214).

When a navigation mode is selected and a destination of the vehicle is input through the inputter 127 provided in the center fascia or the input portion 131 of the terminal, the vehicle may also perform the navigation mode of searching for a route from a current location of the vehicle to the destination based on location information related to the current location and location information related to the destination, matching the found route to a map, displaying the map on the display portion 132 of the terminal, and outputting road guidance information.

While the vehicle travels in the manual driving mode, the vehicle determines whether the current location is a preset location.

Here, the determining of whether the current location is the preset location may include determining whether the current location is an entry location of a tollgate, an entry location of a curvy road, an entry location of a school zone, or an entry location of a speed restriction section.

An example in which the current location is the entry location of the tollgate will be described in an exemplary embodiment of the present invention.

The determining of whether the current location is the preset location includes comparing the current location received by the location receiver with the preset location stored in the storage and determining whether the two locations are the same.

Furthermore, the determining of whether the current location is the preset location may include determining whether an image of the tollgate is present in an image acquired by the image acquirer, and when the image of the tollgate is present in the acquired image, determining that the current location is the preset location.

When it is determined that the current location is the entry location of the tollgate (215), the vehicle determines whether a lane, in which the vehicle is traveling, is a high pass lane or a toll ticket lane.

Here, the entry location of the tollgate may be a location which is spaced from the tollgate by a preset distance.

The determining of whether the lane, in which the vehicle is traveling, is the high pass lane or the toll ticket lane may include determining whether an image of the phrase “high pass” is present in the image acquired by the image acquirer and determining whether the phrase “toll ticket” is present in the image acquired by the image acquirer.

When it is determined that the vehicle is traveling in the high pass lane (216), the vehicle determines whether a speed restriction section is present in the high pass lane based on the image acquired by the image acquirer (217).

Furthermore, the vehicle may determine, based on navigation information, whether the speed restriction section is present in the high pass lane.

That is, when the vehicle is at the entry location of the tollgate, the vehicle determines whether a lane of the vehicle is the high pass lane and whether the speed restriction section is present based on the image acquired by the image acquirer. When it is determined that the lane of the vehicle is the high pass lane and the speed restriction section is not present in the lane of the vehicle, the vehicle confirms a driving speed. When the confirmed driving speed is greater than or equal to a speed limit, the vehicle outputs guidance information for a request to reduce the driving speed.

When it is determined that the lane of the vehicle is the high pass lane and the speed restriction section is not present in the lane of the vehicle, the vehicle reduces a damping force of the damper (218).

Furthermore, before the vehicle travels in the speed restriction section, the vehicle may adjust a height of the vehicle body through a control of the suspension to raise the height of the vehicle body and then may pass through the speed restriction section.

The vehicle compares current location information with location information related to the tollgate to determine whether the vehicle has passed through the tollgate (219). When it is determined that the vehicle has passed through the tollgate, the vehicle performs a return control (220). That is, the vehicle increases the damping force of the damper to a reference damping force. Furthermore, when the height of the vehicle body is adjusted, the vehicle may adjust the height of the vehicle body to a reference height.

When it is determined that the lane of the vehicle is the toll ticket lane, the vehicle determines whether a speed restriction section is present in the toll ticket lane based on the image acquired by the image acquirer (221).

Furthermore, the vehicle may determine whether the speed restriction section is present in the toll ticket lane based on navigation information.

That is, when the vehicle is at the entry location of the tollgate, the vehicle determines whether the lane of the vehicle is the toll ticket lane and whether the speed restriction section is present based on the image acquired by the image acquirer. When the lane of the vehicle is the toll ticket lane and the speed restriction section is present in the lane of the vehicle, the vehicle reduces the damping force of the damper, opens the window provided in the door adjacent to the driver seat, and adjusts the height of the vehicle body based on a height of a toll ticket dispenser (222).

Furthermore, the vehicle determines whether a lane in which the vehicle is traveling is the high pass lane or the toll ticket lane based on whether the vehicle is configured for communicating with a high pass terminal of the tollgate. When it is determined that the lane is the toll ticket lane, the vehicle may open the window provided in the door adjacent to the driver seat.

Furthermore, before the vehicle travels in the speed restriction section, the vehicle may adjust the height of the vehicle body through a control of the suspension to raise the height of the vehicle body and then pass through the speed restriction section.

The vehicle compares current location information with the location information related to the tollgate to determine whether the vehicle has passed through the tollgate (223). When it is determined that the vehicle has passed through the tollgate, the vehicle performs a return control (224). The vehicle closes the window provided in the door adjacent to the driver seat and increases the damping force of the damper to the reference damping force. Furthermore, when the height of the vehicle body is adjusted before the vehicle passes through the toll gate, the vehicle may adjust the height of the vehicle body to the reference height.

When the vehicle is at the entry location of the tollgate, the vehicle determines whether the lane of the vehicle is the toll ticket lane and whether the speed restriction section is present based on the image acquired by the image acquirer. When it is determined that the lane of the vehicle is the toll ticket lane and the speed restriction section is not present in the lane of the vehicle, the vehicle opens the window provided in the door adjacent to the driver seat and adjusts the height of the vehicle body to be the height of the toll ticket dispenser (225).

In the instant case, when the height of the vehicle body is adjusted, the vehicle starts to adjust the height of the vehicle body at a location of the vehicle which is spaced a certain distance from a location of the toll ticket dispenser or a toll booth

The vehicle compares current location information with the location information related to the tollgate to determine whether the vehicle has passed through the tollgate (223). When it is determined that the vehicle has passed through the tollgate, the vehicle performs the return control (224). That is, the vehicle closes the window provided in the door adjacent to the driver seat and increases the damping force of the damper to the reference damping force.

The vehicle may also readjust the height of the vehicle body at the toll booth based on the height of the toll booth.

Furthermore, during the autonomous driving mode, the vehicle may determine whether the vehicle travels on a curvy road based on navigation information. When it is determined that the vehicle travels on the curvy road, the vehicle may decrease a driving speed of the vehicle and may increase the damping force of the damper.

During the manual driving mode, the vehicle may determine whether the vehicle travels on the curvy road based on the navigation information. When it is determined that the vehicle travels on the curvy road, the vehicle may also increase the damping force of the damper

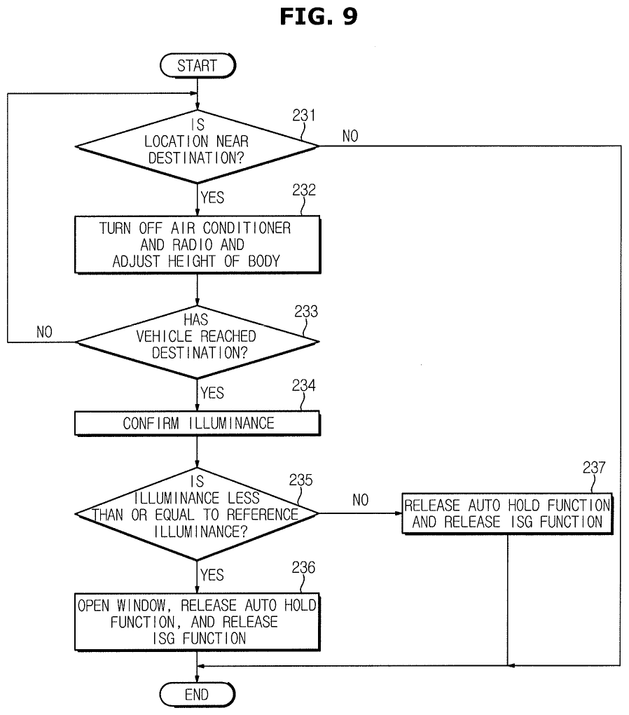

FIG. 9 is a control flowchart of a vehicle according to an exemplary embodiment and is a control flowchart of the vehicle when a preset location is a destination.

During an autonomous driving mode or a manual driving mode, the vehicle compares location information related to a current location of the vehicle with location information related to the destination. When it is determined that a distance between the current location and the destination is a reference distance, the vehicle determines that the current location is near the destination.

That is, when it is determined that the current location is near the destination, the vehicle determines whether an air conditioner is in an operating state. When it is determined that the air conditioner is in the operating state, the vehicle turns the air conditioner off, reducing fuel costs and preventing odors from being generated in the air conditioner.

Furthermore, when it is determined that the current location is near the destination, the vehicle may operate only a blast fan of the air conditioner.

Furthermore, when it is determined that the current location is near the destination, the vehicle determines whether a radio is in an operating state. When it is determined that the radio is in the operating state, the vehicle turns the radio off.

Furthermore, when a type of the vehicle is a sports utility vehicle (SUV), the vehicle lowers a height of a vehicle body (232). As a result, a user may easily exit the vehicle.

The vehicle compares location information related to the current location with location information related to the destination to determine whether the current location is the destination (233). When it is determined that the current location is the destination, the vehicle confirms illuminance detected by an illumination detector (234). The vehicle determines whether the confirmed external illuminance is less than or equal to a reference illuminance (235).

When it is determined that the confirmed external illuminance is less than or equal to the reference illuminance, the vehicle opens the window provided in the door adjacent to the driver seat, securing a field of view during parking.

Furthermore, when the current location is the destination and an external temperature detected by a temperature detector is less than or equal to reference temperature, the vehicle may maintain a closed state of the window provided in the door adjacent to the driver seat.

When external illuminance is greater than or equal to the reference illuminance and the external temperature is less than or equal to the reference temperature based on setting information set by a user, the vehicle may also open the window provided in the door adjacent to the driver seat and may also maintain the closed state of the window provided in the door adjacent to the driver seat.

The vehicle confirms whether an auto hold function and an ISG function are being performed. When at least one function is being performed, the vehicle releases the function which is being performed (236).

On the other hand, when it is determined that the confirmed external illuminance exceeds the reference illuminance, the vehicle confirms whether the auto hold function and the ISG function are being performed. When at least one function is being performed, the vehicle releases the function which is being performed (237).

The auto hold function and the ISG function are released as described above, preventing braking from being performed during parking and allowing a driver to not feel uncomfortable due to an engine being turned off during the parking.

Furthermore, when it is determined that the current location is the destination, the vehicle controls a steering device to adjust a turning radius to a preset turning radius or adjust a steering ratio to a preset gear ratio, facilitating parking.

As described above, when the current location is the destination, a parking lot, or a preset location, the vehicle controls a brake (auto hold device), an engine controller (ISG device), a window, and a steering device (AFS or RWS device).

Due to such a control according to driving conditions, the driver may feel comfort and convenience in accordance with a driving situation.

As is apparent from the above description, when a current location or a preset location is determined based on external information related to the vehicle (navigation information, camera image information, or the like), it is possible to control a driving speed and also control at least one of a suspension, an air conditioner, a window, an engine, a brake, and steering device, improving stability of the vehicle and riding quality and allowing a driver to feel comfort and convenience in accordance with a driving situation.

As described above, according to an exemplary embodiment of the present invention, it is possible to improve quality and merchantability of a vehicle or a terminal which performs a navigation mode and an autonomous driving mode and to increase satisfaction of a user.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An autonomous driving control apparatus comprising:
an image acquirer configured to acquire an image of a road;
an inputter through which a destination of a vehicle is input;
a storage configured to store location information related to a predetermined location and image information corresponding to the predetermined location;
a location receiver configured to receive a current location of the vehicle; and
a controller configured to generate a route from the received current location to the destination, control driving of the vehicle based on route information related to the generated route and image information related to the acquired image, and reduce a driving speed of the vehicle when the current location is determined to be the predetermined location based on the image information related to the acquired image and the stored image information.

2. The autonomous driving control apparatus of claim 1,
wherein the controller is configured to determine when a speed restriction section is present on a travel lane of the road based on the image information related to the acquired image, and when the speed restriction section is determined to be present, the controller is configured to control a suspension of the vehicle to adjust a damping force of a damper of the suspension and a height of a vehicle body.

3. The autonomous driving control apparatus of claim 1,
wherein, when the predetermined location is determined to be an entry location of a tollgate, the controller is configured to determine when a travel lane of the vehicle is a toll ticket lane based on the image information related to the acquired image, and when the travel lane is determined to be the toll ticket lane, the controller is configured to control an opening and closing device to open a window adjacent to a driver seat of the vehicle and to control a suspension of the vehicle to adjust a height of a vehicle body.

4. The autonomous driving control apparatus of claim 3,
wherein the controller is configured to control the suspension to start to adjust the height of the vehicle body at a location of the vehicle which is spaced a predetermined distance from a location of a toll ticket dispenser and a location of a toll booth.

5. The autonomous driving control apparatus of claim 3,
wherein the controller is configured to determine when the vehicle has passed through the tollgate based on the image information related to the acquired image, and
wherein when the vehicle is determined to has passed through the tollgate, the controller is configured to control the opening and closing device to close the window adjacent to the driver seat and to control the suspension to return the height of the vehicle body to an original height thereof.

6. The autonomous driving control apparatus of claim 1, wherein the controller is configured to verify a distance between the current location and the destination based on location information related to the received current location and location information related to the destination, and when the verified distance is determined to be a reference distance, the controller is configured to perform a control to turn off an air conditioner, a radio, and an audio device in the vehicle.

7. The autonomous driving control apparatus of claim 1, wherein, when the current location is determined to be the destination, the controller is configured to control an opening and closing device to open a window adjacent to a driver seat of the vehicle.

8. The autonomous driving control apparatus of claim 1, wherein, when the current location is determined to be the destination, the controller is configured to release an automatic on/off function of an engine of the vehicle and an automatic on/off function of a brake of the vehicle.

9. A vehicle comprising:
a power device configured to apply a driving force to a wheel of the vehicle;
a brake configured to apply a braking force to the wheel;
an image acquirer configured to acquire an image of a road;
an inputter through which a destination of the vehicle is input;
a storage configured to store location information related to a predetermined location and image information corresponding to the predetermined location;
a location receiver configured to receive a current location of the vehicle; and
a controller configured to generate a route from the received current location to the destination during an autonomous driving mode, to control driving of the vehicle based on route information related to the generated route and image information related to the acquired image, and to control operation of at least one of the power device and the brake to reduce a driving speed of the vehicle when the current location is determined to be the predetermined location based on the image information related to the acquired image and the stored image information.

10. The vehicle of claim 9, further including:
a suspension of the vehicle configured to mitigate a shock and a vibration to the vehicle from a road surface,
wherein the controller is configured to determine when a speed restriction section is present on a travel lane of the road based on the image information related to the acquired image, and when the speed restriction section is determined to be present, the controller is configured to control the suspension to adjust a damping force of a damper of the suspension and a height of a vehicle body.

11. The vehicle of claim 9, further including:
a suspension of the vehicle configured to mitigate a shock and a vibration to the vehicle from a road surface; and
an opening and closing device configured to open or close a window of a door of the vehicle,
wherein, when the predetermined location is determined to be an entry location of a tollgate, the controller is configured to determine when a travel lane of the vehicle is a toll ticket lane based on the image information related to the acquired image, and
wherein, when the travel lane is determined to be the toll ticket lane, the controller is configured to control the opening and closing device to open a window adjacent to a driver seat of the vehicle and is configured to control the suspension to adjust a height of a vehicle body.

12. The vehicle of claim 9, further including a suspension of the vehicle configured to mitigate a shock and a vibration to the vehicle from a road surface,
wherein, during a manual driving mode of the vehicle, when the predetermined location is determined to be an entry location of a tollgate, the controller is configured to determine when a speed restriction section is present on a travel lane of the road based on the image information related to the acquired image, and when the speed restriction section is determined to be present, the controller is configured to control the suspension to reduce a damping force of a damper of the suspension and raise a height of a vehicle body.

13. The vehicle of claim 12, further including an opening and closing device configured to open or close a window of a door of the vehicle,
wherein, during the manual driving mode, the controller is configured to determine when the travel lane of the vehicle is a toll ticket lane based on the image information related to the acquired image, and
wherein when the travel lane is determined to be the toll ticket lane, the controller is configured to control the opening and closing device to open a window adjacent to a driver seat of the vehicle and controls the suspension to adjust the height of the vehicle body.

14. The vehicle of claim, 13, wherein the controller is configured to control the suspension to start to adjust the height of the vehicle body at a location of the vehicle which is spaced a predetermined distance from a location of the tollgate.

15. The vehicle of claim 13, wherein the controller is configured to determine when the vehicle has passed through the tollgate based on the image information related to the acquired image, and when the vehicle is determined to has passed through the tollgate, the controller is configured to control the opening and closing device to close the window adjacent to the driver seat and to control the suspension to return the height of the vehicle body to an original height thereof.

16. The vehicle of claim 9,
wherein the controller is configured to verify a distance between the current location and the destination based on location information related to the received current location and location information related to the destination, and
wherein when the verified distance is determined to be a reference distance, the controller is configured to perform a control to turn off an air conditioner, a radio, and an audio device in the vehicle.

17. The vehicle of claim 9, further including:
an opening and closing device configured to open or close a window of a door of the vehicle; and
an illumination detector configured to detect external illuminance,
wherein, when the current location is determined to be the destination, the controller is configured to verify the detected external illuminance, and,
wherein when the verified external illuminance is less than or equal to a reference illuminance, the controller is configured to control the opening and closing device to open a window adjacent to a driver seat of the vehicle.

18. The vehicle of claim 9, wherein, when the current location is determined to be the destination, the controller is configured to release an automatic on/off function of an engine of the vehicle and an automatic on/off function of the brake.

19. A vehicle comprising:
a power device configured to apply a driving force to a wheel of the vehicle;
a brake configured to apply a braking force to the wheel;
a suspension configured to mitigate a shock and a vibration to the vehicle from a road surface;
an opening and closing device configured to open or close a window of a door of the vehicle;
an image acquirer configured to acquire an image of a road;
an inputter through which a destination of the vehicle is input;
a storage configured to store entry location information related to a tollgate;
a location receiver configured to receive a current location of the vehicle;
a controller configured to generate a route from the received current location to the destination, to control road guidance based on route information related to the generated route, to determine when a speed restriction section is present in a travel lane of the vehicle and a type of the travel lane of the vehicle based on image information related to the acquired image when the received current location is determined to be an entry location of the tollgate, to control a damping force of the suspension to be reduced when the speed restriction section is determined to be present, and to control the opening and closing device to open or close the window when the type of the travel lane of the vehicle is determined to be a toll ticket lane; and
a display configured to display the generated route and road guidance information.

20. The vehicle of claim 19, further including:
an illumination detector configured to detect external illuminance,
wherein the controller is configured to verify a distance between the current location and the destination based on location information related to the received current location and location information related to the destination,
wherein when the verified distance is determined to be a reference distance, the controller is configured to perform a control to turn off an air conditioner, a radio, and an audio device in the vehicle,
wherein when the current location is determined to be the destination, the controller is configured to verify the detected external illuminance, and
wherein when the verified external illuminance is less than or equal to a reference illuminance, the controller is configured to control the opening and closing device to open a window adjacent to a driver seat of the vehicle.

21. A method of controlling a vehicle, the method comprising:
when a destination of the vehicle is received, generating, by a controller, a route to the destination;
controlling, by the controller, road guidance based on route information related to the generated route;
determining, by the controller, when a current location of the vehicle is an entry location of a tollgate based on image information related to an image acquired by an image acquirer;
when the current location is determined to be the entry location of the tollgate, determining, by the controller, when a speed restriction section is present in a travel lane of the vehicle and a type of the travel lane of the vehicle based on the image information related to the acquired image;
when the speed restriction section is present, controlling, by the controller, a suspension of the vehicle to reduce a damping force of the suspension and raise a height of a door of the vehicle; and
when the type of the travel lane of the vehicle is determined to be a toll ticket lane, controlling, by the controller, an opening and closing device to open a window adjacent to a driver seat of the vehicle.

22. The method of claim 21, further including, when a driving mode of the vehicle is an autonomous driving mode, controlling, by the controller, operation of at least one of a power device and a brake of the vehicle to reduce a driving speed of the vehicle at the entry location of the tollgate.

23. The method of claim 21, further including:
verifying, by the controller, a distance between the current location and the destination based on location information related to the current location and location information related to the destination;
when the verified distance is determined to be a reference distance, performing, by the controller, a control to turn off an air conditioner, a radio, and an audio device in the vehicle;
when the current location is determined to be the destination, verifying, by the controller, a detected illuminance; and
when the verified external illuminance is less than or equal to a reference illuminance, controlling, by the controller, the opening and closing device to open the window adjacent to the driver seat.

24. The method of claim 21, further including:
when the type of the travel lane of the vehicle is the toll ticket lane, verifying, by the controller, a location of the tollgate based on the image information related to the image acquired by the image acquirer; and
controlling, by the controller, the suspension to start to adjust a height of a vehicle body at a location of the vehicle which is spaced a predetermined distance from the location of the tollgate.
